(19) United States
(12) Patent Application Publication
(10) Pub. No.: US 2013/0218686 A1
(43) Pub. Date: Aug. 22, 2013

(54) Methods and Systems For Group Offers Within Group Chat

(71) Applicants: Greg Muchnik, Champaign, IL (US); Matthew Ahrens, Champaign, IL (US); Aaron J. Klish, St. Joseph, IL (US)

(72) Inventors: Greg Muchnik, Champaign, IL (US); Matthew Ahrens, Champaign, IL (US); Aaron J. Klish, St. Joseph, IL (US)

(73) Assignee: Yahoo! Inc., Sunnyvale, CA (US)

(21) Appl. No.: 13/398,522

(22) Filed: Feb. 16, 2012

(51) Int. Cl. G06Q 30/02; G06F 3/01

(52) U.S. Cl. 705/14.66

(57) ABSTRACT

Techniques are provided which engage users and increase social interaction in group buying. Methods and systems may target a group of users if a group chat with one or more group offers based at least in part on the group chat information. The group offer may be displayed in the chat client. Users' responses to the proposed deal may be tracked. The group offer may be updated based at least in part on the users' responses to the group offer. The updated group offer may be displayed in the chat client.

### BACKGROUND

Recently, group buying has been increasing in popularity. Group buying is a valuable tool that increases advertising engagement because it guarantees commitment to the advertiser or to the business. However, it may be challenging to find relevant groups of users who may be targeted together with the prospect of them all committing to a deal.

There is a need for techniques in online advertising relating to, among other things, encouraging group buying behavior through social interaction among users who participate in group buying.

### SUMMARY

Some embodiments of the invention provide systems and methods in which a group of users in a group chat may be targeted with one or more group offers. A group of users may be allowed to enter a group chat hosted by a chat client. Users may access the chat client using mobile devices such as, for example, smart phones, tablets, etc. Alternatively, or in addition, the chat client may be accessed using desktop or laptop PCs. The chat client may be an instant messaging client, such as for example, Yahoo! Messenger. Information relating to the group chat may be received by a server. In some embodiments, the information relating to the group chat may comprise the group chat name, number of users in the chat, geographic locations of the users in the chat, other information relating to the users in the group chat (e.g., user profile information), parsed text of the chat conversation, etc.

A group offer may be presented to the group of users in the group chat based on the received information relating to the group chat. The group offer may be displayed in the chat client. The group offer may comprise one or more group deals and/or advertisements. One or more advertisers may setup a group offer through an advertising interface. The advertisers may specify, through the advertising interface, one or more targeting criteria or attributes for the group offer, and may also specify how the group offer may be dynamically updated based on user responses. For example, an advertiser may specify that they want to target group chats which include male users between the ages of 21-30. In addition, they may specify that the group offer should increase the discount by 1% for each unique click/conversion of the group offer.

Users may click on the group offer directly from within the chat client. In some embodiments, the users may discuss the group offer within the chat and convince each other to act on the group offer. For example, the group offer may be for a 10% discount at a local restaurant. However, the group offer may specify that the discount will increase to 20% if five or more users commit to the group offer. Thus, users may discuss the offer and attempt to convince additional users to commit to the offer in order to get a larger discount.

The displayed group offer may be dynamically updated based on responses to the group offer from one or more users in the group of users. As more users commit to the offer, the offer may be updated to reflect the additional commitments. Using the above example, once three users have committed, the offer may be updated to include a 15% discount, and once the number of committed users reaches five users, the offer may be updated once again to reflect a 20% discount. In some embodiments, the chat client may display real time updates which may display, for example, how many users have acted on the group offer (clicks, conversions, etc.). This may advantageously encourage other users to also act on the group offer. In some embodiments, all user responses to the group offer (e.g., clicks, conversions, etc.) may be transmitted to one or more servers (e.g., the advertising server). The one or more servers may update the group offer based at least in part on the user responses (and the criteria specified by the advertisers), and transmit the updated group offer to the chat client. The chat client may display the updated group offer in the chat client.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is a block diagram illustrating one embodiment of the invention.

### DETAILED DESCRIPTION

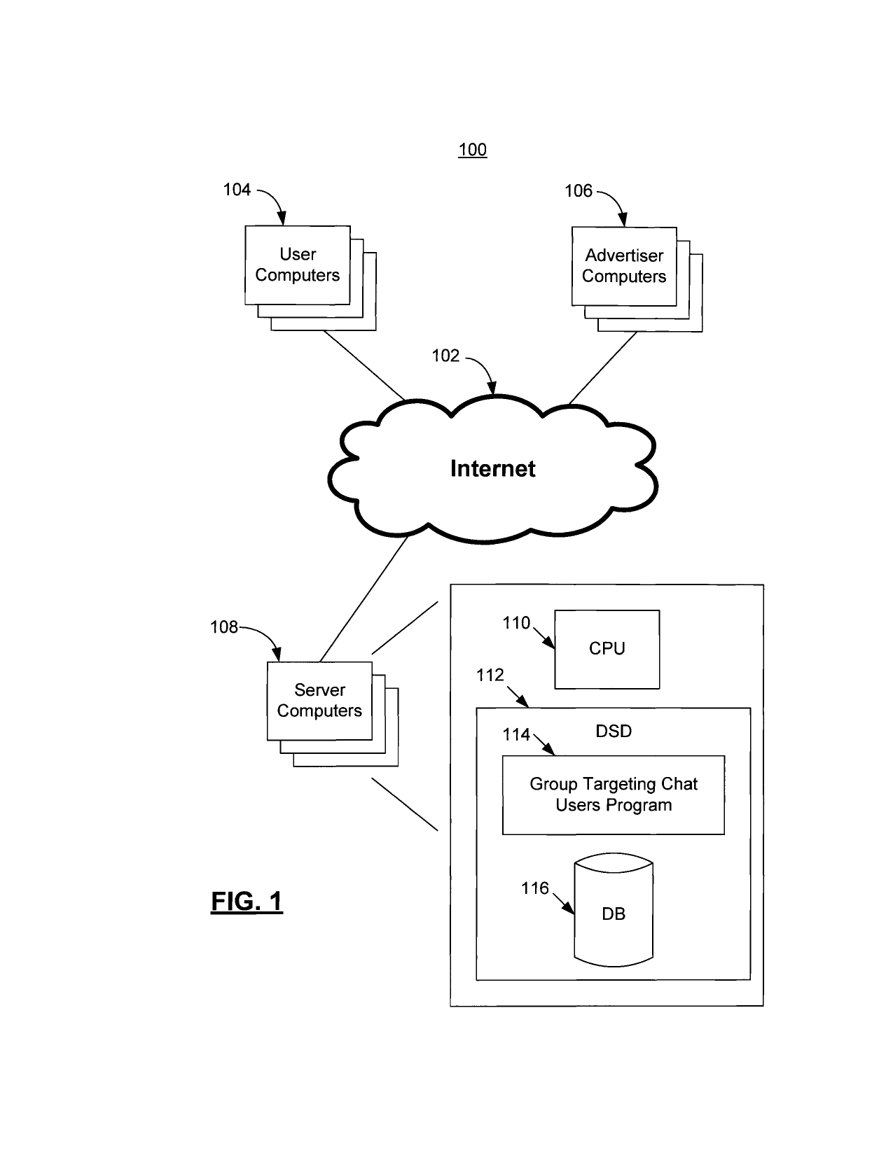

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers 104 may be or include desktop or laptop PCs, as well as, wireless, mobile, or handheld devices such as cell phones, PDAs, tablets, etc.

Each of the one or more computers 104, 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Group Targeting Chat Users Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

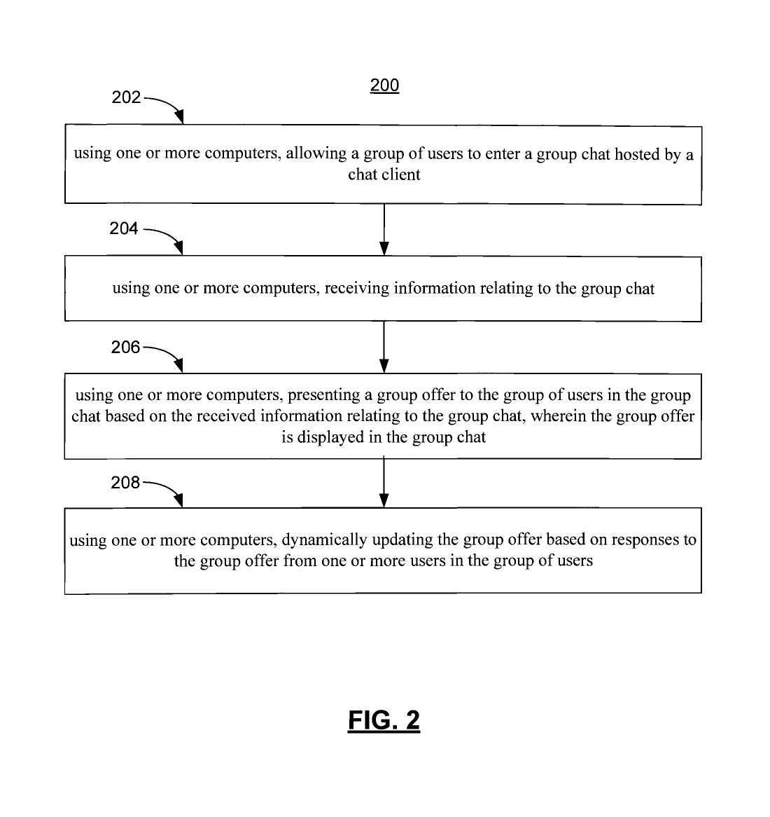

FIG. 2 is a flow diagram illustrating a method 200 according to one embodiment of the invention. At step 202, using one or more computers, a group of users may be allowed to enter a group chat hosted by a chat client. Users may access the chat client using mobile devices such as, for example, smart phones, tablets, etc. Alternatively, or in addition, the chat client may be accessed using desktop or laptop PCs. The chat client may be an instant messaging client, such as for example, Yahoo! Messenger. At step 204, using one or more computers, information relating to the group chat may be received. The information may be received, for example, at a server. In some embodiments, the information relating to the group chat may comprise the group chat name, number of users in the chat, geographic locations of the users in the chat, other information relating to the users in the group chat (e.g., user profile information), parsed text of the chat conversation, etc.

At step 206, using one or more computers, a group offer may be presented to the group of users in the group chat based on the received information relating to the group chat. The group offer may be displayed in the chat client. In some embodiments, the chat client may include a reserved space for display of group offers. The group offer may comprise one or more group deals and/or advertisements. The group offer may be selected, for example, by an advertising server based at least in part on the information relating to the group chat. The advertising server may receive the information relating to the group chat directly from the chat client. Alternatively, or in addition, the advertising server may receive the information from another server. One or more advertisers may setup a group offer through an advertising interface. The advertisers may specify, through the advertising interface, one or more targeting criteria or attributes for the group offer, and may also specify how the group offer may be dynamically updated based on user responses. For example, an advertiser may specify that they want to target group chats which include male users between the ages of 21-30. In addition, they may specify that the group offer should increase the discount by 1% for each unique click/conversion of the group offer.

Users may click on the group offer directly from within the chat client. In some embodiments, the users may discuss the group offer within the chat and convince each other to act on the group offer. For example, the group offer may be for a 10% discount at a local restaurant. However, the group offer may specify that the discount will increase to 20% if five or more users commit to the group offer. Thus, users may discuss the offer and attempt to convince additional users to commit to the offer in order to get a larger discount.

At step 208, using one or more computers, the displayed group offer may be dynamically updated based on responses to the group offer from one or more users in the group of users. As more users commit to the offer, the offer may be updated to reflect the additional commitments. Using the above example, once three users have committed, the offer may be updated to include a 15% discount, and once the number of committed users reaches five users, the offer may be updated once again to reflect a 20% discount. In some embodiments, the chat client may display real time updates which may display, for example, how many users have acted on the group offer (clicks, conversions, etc.). This may advantageously encourage other users to also act on the group offer. In some embodiments, all user responses to the group offer (e.g., clicks, conversions, etc.) may be transmitted to one or more servers (e.g., the advertising server). The one or more servers may update the group offer based at least in part on the user responses (and the criteria specified by the advertisers), and transmit the updated group offer to the chat client. The chat client may display the updated group offer in the chat client.

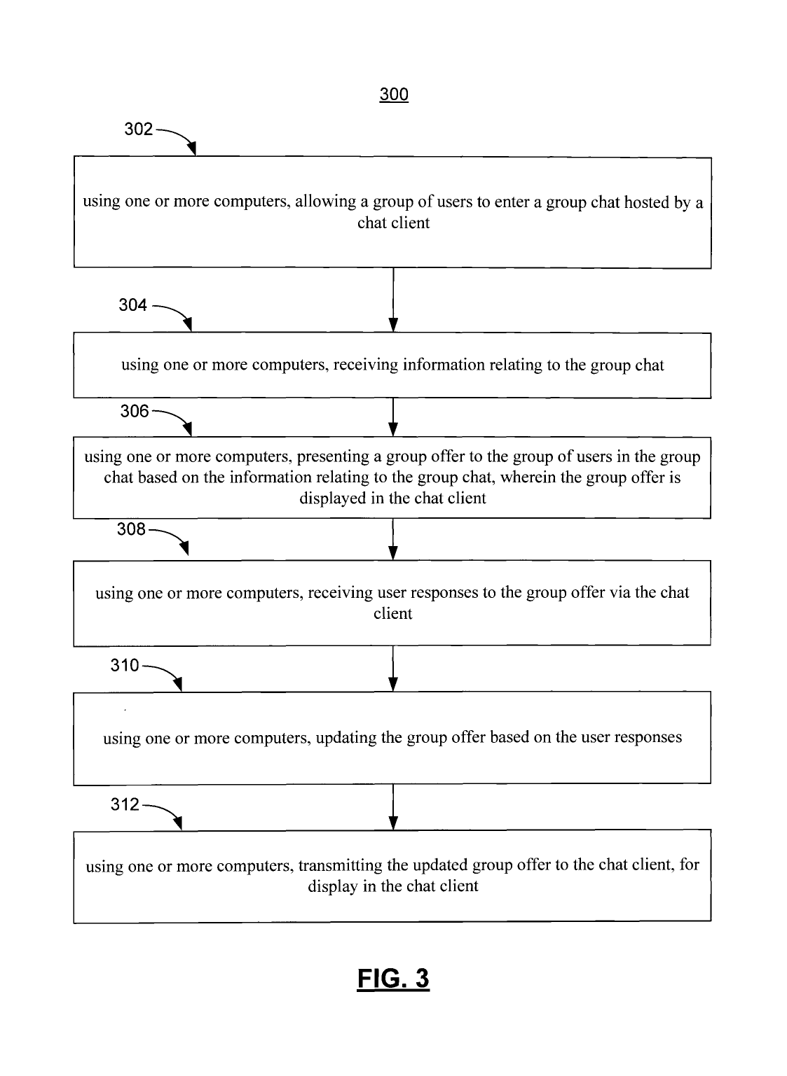

FIG. 3 is a flow diagram illustrating a method 300 according to one embodiment of the invention. At step 302, using one or more computers, a group of users may be allowed to enter a group chat hosted by a chat client. Users may access the chat client using mobile devices such as, for example, smart phones, tablets, etc. Alternatively, or in addition, the chat client may be accessed using desktop or laptop PCs. The chat client may be an instant messaging client, such as for example, Yahoo! Messenger. At step 304, using one or more computers, information relating to the group chat may be received. The information may be received, for example, at a server. In some embodiments, the information relating to the group chat may comprise the group chat name, number of users in the chat, geographic locations of the users in the chat, other information relating to the users in the group chat (e.g., user profile information), parsed text of the chat conversation, etc.

At step 306, using one or more computers, a group offer may be presented to the group of users in the group chat based on the received information relating to the group chat. The group offer may be displayed in the chat client.

At step 308, using one or more computers, user responses to the group offer may be received via the chat client. In some embodiments, the chat client may transmit the user responses to a server. At step 310, using one or more computers, the group offer may be updated based at least in part on the user responses (and the criteria specified by the advertisers). In some embodiments, the server may update the group offer based at least in part on the user responses (and the criteria specified by the advertisers), and transmit the updated group offer to the chat client (step 312). The chat client may display the updated group offer in the chat client.

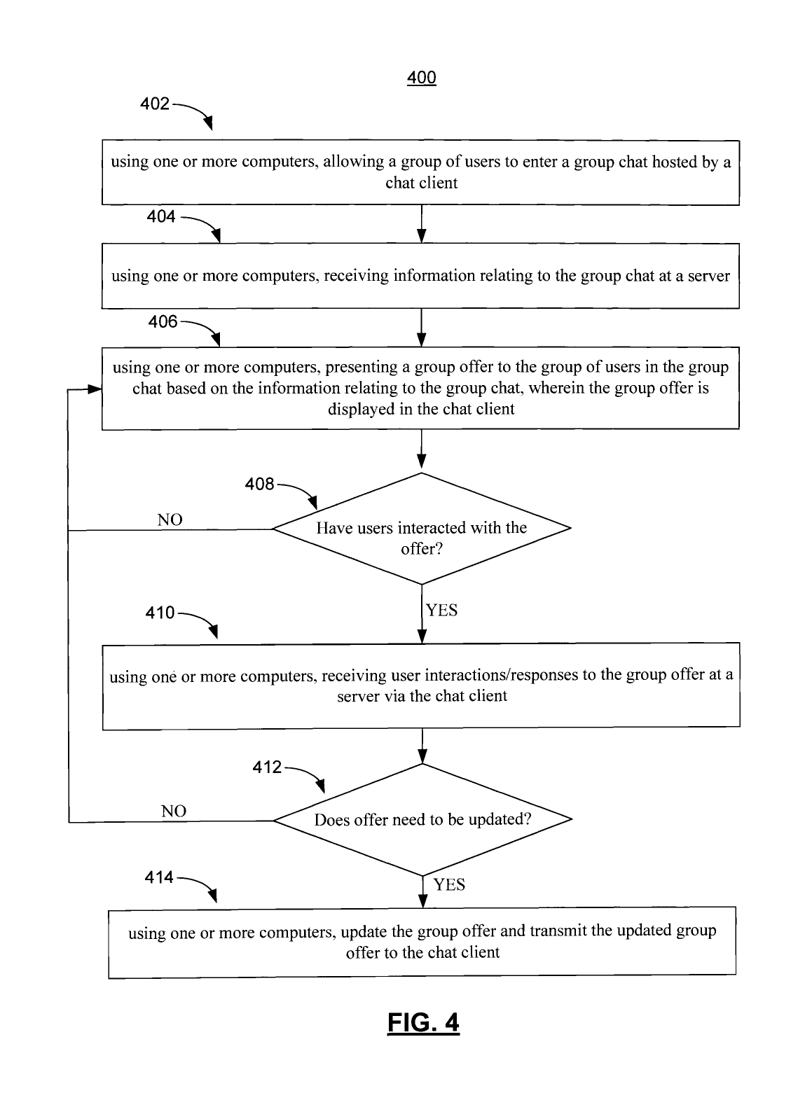

FIG. 4 is a flow diagram illustrating a method 400 according to one embodiment of the invention. At step 402, using one or more computers, a group of users may be allowed to enter a group chat hosted by a chat client. Users may access the chat client using mobile devices such as, for example, smart phones, tablets, etc. Alternatively, or in addition, the chat client may be accessed using desktop or laptop PCs. The chat client may be an instant messaging client, such as for example, Yahoo! Messenger. At step 404, using one or more computers, information relating to the group chat may be received at a server. The server may be for example, an advertising server. In some embodiments, the information relating to the group chat may comprise the group chat name, number of users in the chat, geographic locations of the users in the chat, other information relating to the users in the group chat (e.g., user profile information), parsed text of the chat conversation, etc.

At step 406, using one or more computers, a group offer may be presented to the group of users in the group chat based on the received information relating to the group chat. The group offer may be displayed in the chat client. The group offer may be selected by the server based on the received information relating to the group chat and the offer may be transmitted to the chat client by the server.

At step 408, it may be determined if one or more users in the chat have interacted and/or responded with the group offer. Interactions and/or responses may include clicks, conversions, etc. If one or more users have interacted and/or responded to the group offer, using one or more computers, the user interactions/responses to the group offer may be transmitted to a server via the chat client, as depicted in step 410. It may then be determined at the server, based on the received information regarding interactions/responses, if the group offer needs to be updated, as depicted in step 412. The server may determine if the group offer needs to be updated based at least on the received information and on the criteria specified by the advertiser(s). If the group offer needs to be updated, the group offer may be updated as specified by the advertiser(s), and the updated offer may be transmitted to the chat client as shown in step 414. The chat client may then display the updated group offer.

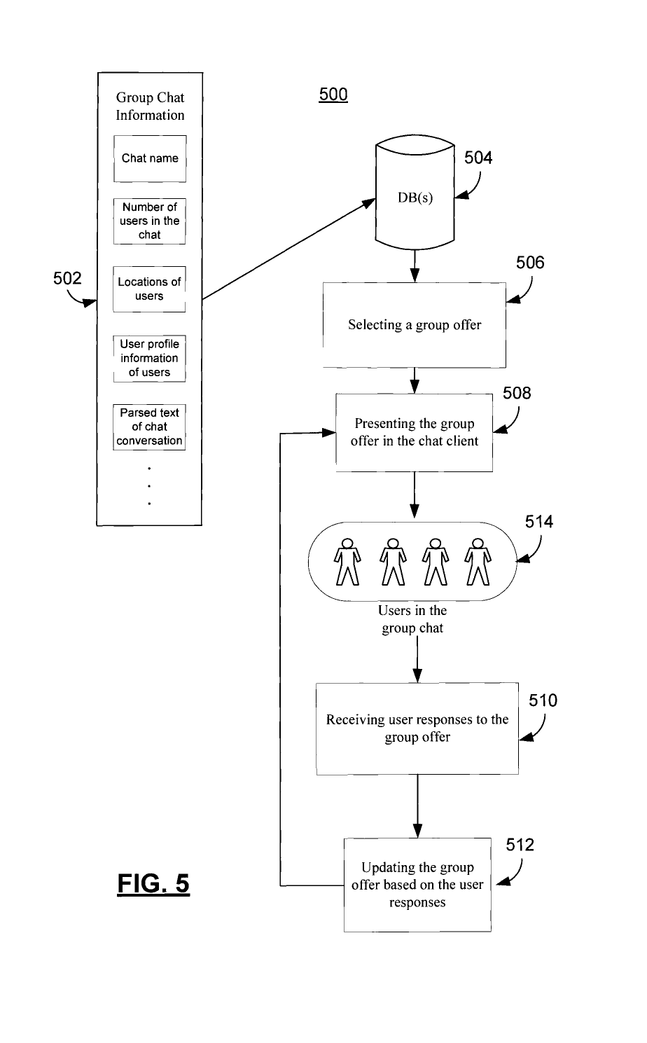

FIG. 5 is a block diagram 500 illustrating one embodiment of the invention. One or more data stores or databases 504 are depicted. Various types of information are stored in the database 504, which information may be obtained, gathered, or generated in various ways. Database 504 may be located in, for example, one or more server computers 108 (FIG. 1) and/or one or more advertiser computers 106 (FIG. 1). In particular, types of depicted information stored or collected by database 504 include group chat information 502 pertaining to one or more group chats. Group chat information 502 may comprise, among other things, group chat name, number of users in the chat, geographic locations of the users in the chat, other information relating to the users in the group chat (e.g., user profile information), parsed text of the chat conversation, etc.

As depicted in block 506, one or more of these types of information (in conjunction with advertiser specified targeting criteria), possibly among other types, maybe used to select a group offer to be targeted to the users in a group chat. In some embodiments, group offer may comprise one or more deals and/or advertisements, which may include textual, graphical, audio, video and/or link data.

The group offer may then be transmitted to the chat client, and presented to the group of users in the chat client as depicted in block 508. In some embodiments, the chat client may include a reserved space for display of group offers. Users may click on the group offer directly from within the chat client. In some embodiments, the users may discuss the group offer within chat 514 and convince each other to act on the group offer.

Users may click on the group offer directly from within the chat client. User responses to the group offer may be received at one or more servers as depicted in the block 510. For example, the group offer may be for a 10% discount at a local restaurant. However, the group offer may specify that the discount will increase to 20% if five or more users commit to the group offer. Thus, users may discuss the offer and attempt to convince additional users to commit to the offer in order to get a larger discount.

In some embodiments, all user responses to the group offer (e.g., clicks, conversions, etc.) may be transmitted to one or more servers (e.g., one or more advertiser computers 106 (FIG. 1) and/or one or more server computers 108 (FIG. 1)). The one or more servers (e.g., one or more advertiser computers 106 (FIG. 1) and/or one or more server computers 108 (FIG. 1)) may update the group offer based at least in part on the user responses (and the criteria specified by the advertisers), as depicted in the block 512, and transmit the updated group offer to the chat client. The chat client may display the updated group offer in the chat client. The chat client may also display real-time updates which allow chat users to see how many users have acted on the group offer (e.g., clicks, conversions, etc.).

While the invention is described with reference to the above drawings, the drawings are intended to be illustrative, and the invention contemplates other embodiments within the spirit of the invention.

1. A method comprising:
using one or more computers, allowing a group of users to enter a group chat hosted by a chat client;
using one or more computers, receiving information relating to the group chat; and
using one or more computers, presenting a group offer to the group of users in the group chat based on the received information relating to the group chat, wherein the group offer is displayed in the chat client; and
using one or more computers, dynamically updating the displayed group offer based on responses to the group offer from one or more users in the group of users.

2. The method of claim 1, further comprising:
using one or more computers, allowing an advertiser to setup the group offer through an advertising interface.

3. The method of claim 2, further comprising:
using one or more computers, allowing the advertiser to specify one or more targeting attributes for the group of users; and
using one or more computers, allowing the advertiser to specify how the group offer will be dynamically updated based on responses to the group offer from one or more users in the group of users.

4. The method of claim 1, wherein the group offer is displayed in a space reserved for the group offer in the chat client.

5. The method of claim 1, wherein receiving the information relating to the group chat comprises receiving the information at a server via the chat client.

6. The method of claim 5, wherein the server is configured to select the group offer based on the received information relating to the group chat, and transmit the group offer to the chat client for display within the chat client.

7. The method of claim 1, wherein the information relating to the chat comprises group chat name, information relating to one or more users within the group of users, and textual information of a chat conversation.

8. The method of claim 1, further comprising:
using one or more computers, receiving at a server, via the chat client, user responses to the group offer; and
using one or more computers, updating the group offer based on the user responses and transmitting the updated group offer to the chat client.

9. The method of claim 1, further comprising:
using one or more computers, displaying a real-time status of the group offer within the chat client, wherein the real-time status comprises a number of clicks or conversions of the group offer.

10. A system comprising:
one or more server computers coupled to a network; and
one or more databases coupled to the one or more server computers;
wherein the one or more server computers are for:
allowing a group of users to enter a group chat hosted by a chat client;
receiving information relating to the group chat; and
presenting a group offer to the group of users in the group chat based on the received information relating to the group chat, wherein the group offer is displayed in the chat client; and
dynamically updating the displayed group offer based on responses to the group offer from one or more users in the group of users.

11. The system of claim 10, wherein the one or more server computers are further configured for:
allowing an advertiser to setup the group offer through an advertising interface.

12. The system of claim 11, wherein the one or more server computers are further configured for:
allowing the advertiser to specify one or more targeting attributes for the group of users; and
allowing the advertiser to specify how the group offer will be dynamically updated based on responses to the group offer from one or more users in the group of users.

13. The system of claim 10, wherein the group offer is displayed in a space reserved for the group offer in the chat client.

14. The system of claim 10, wherein receiving the information relating to the group chat comprises receiving the information relating to the group chat at the one or more servers via the chat client.

15. The system of claim 14, wherein the one or more servers is configured to select the group offer based on the received information relating to the group chat, and transmit the group offer to the chat client for display within the chat client.

16. The system of claim 10, wherein the information relating to the chat comprises group chat name, information relating to one or more users within the group of users, and textual information of a chat conversation.

17. The system of claim 10, wherein the one or more server computers are further configured for:
receiving, via the chat client, user responses to the group offer;
updating the group offer based on the user responses; and
transmitting the updated group offer to the chat client.

18. The system of claim 10, wherein the one or more server computers are further configured for:
displaying a real-time status of the group offer within the chat client, wherein the real-time status comprises a number of clicks or conversions of the group offer.

19. The system of claim 1, wherein the group offer is an advertisement comprising one or more of textual data, graphical data, video data, and audio data.

20. A computer readable medium or media containing instructions for executing a method comprising:
using one or more computers, allowing a group of users to enter a group chat hosted by a chat client;
using one or more computers, receiving information relating to the group chat;
using one or more computers, presenting a group offer to the group of users in the group chat based on the information relating to the group chat, wherein the group offer is displayed in the chat client;
using one or more computers, receiving user responses to the group offer via the chat client;
using one or more computers, updating the group offer based on the user responses; and
using one or more computers, transmitting the updated group offer to the chat client, for display in the chat client.
